(19) United States
(12) Patent Application Publication
(10) Pub. No.: US 2011/0019428 A1
(43) Pub. Date: Jan. 27, 2011

(54) ILLUMINATION DEVICE

(75) Inventors: CHIH-MING LAI, Chu-Nan (TW); YU-PIN LIU, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/781,819

(22) Filed: May 18, 2010

(30) Foreign Application Priority Data
Jul. 21, 2009 (CN) 200910304621.8

(51) Int. Cl. F21V 21/00

(52) U.S. Cl. 362/382

(57) ABSTRACT

An illumination device includes a light source and a heat dissipation device. The light source includes a base and at least a light emitting diode on the base. The heat dissipation device is located on the base opposite to the light emitting diode, and includes an air pump and a hollow shell. The hollow shell is detachably fixed on the base, and has a first opening and a second opening. The air pump is detachably fixed in the hollow shell. In operation, motion of the air pump generates airflow from the first opening toward the second opening to evacuate heat from the light source.

### BACKGROUND

1 . Technical Field

The present disclosure relates to illumination, and particularly, to a light emitting diode (LED) illumination device.

2. Description of Related Art

LEDs are extensively applied due to high brightness. However, considerable heat is generated by the LED, which, if exceeding a certain limit, can detrimentally affect working voltage, wavelength and luminous intensity of the LED. Accordingly, heat dissipating fins are often attached to the bottom of the LED light source of the illumination device in a manifold configuration. The generated heat is conducted from the LED toward the fins, and dissipated into the exterior by natural convection. Nevertheless, hot air between the fins flows very slowly, so considerable heat remains around the LED. One solution to such problem is to provide electric fans for generating forced air flows. However, the fans are arranged inside the illumination device, which are difficult to access for removal or maintenance. Once the fans are out of order, the LEDs are easily overheated, and the entire illumination device may require disassembly, affecting efficiency and convenience.

Therefore, it is desirable to provide an illumination device which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present image capture device and control method thereof. Moreover, in the drawings, like reference numerals designate corresponding parts throughout the views.

FIG. 1 is a schematic view of an illumination device according to a first embodiment of the present disclosure.

FIG. 2 is a schematic view of an illumination device according to a second embodiment of the present disclosure.

### DETAILED DESCRIPTION

Embodiments of the disclosure will now be described in detail with reference to the accompanying drawings.

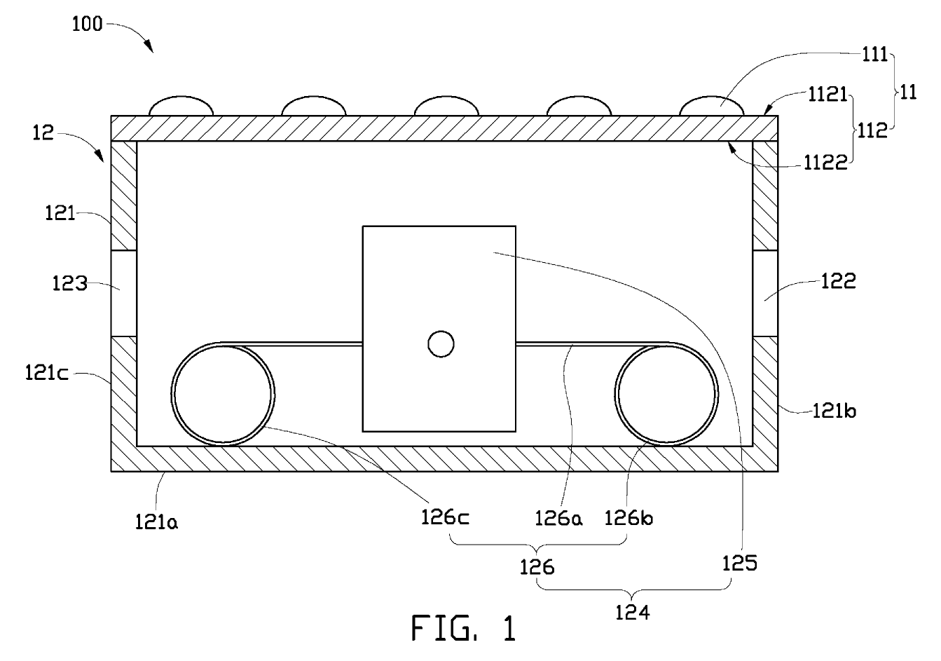

Referring to FIG. 1, an illumination device 100 according to a first embodiment of the present disclosure includes a light source 11 and a heat dissipation device 12. The light source 11 includes a plurality of LEDs 111 and a base 112. The base 112 includes a first surface 1121 and a second surface 1122 opposite thereto. The LEDs 111 are mounted on the first surface 1121 of the base 112, and electrically connected to the base 112.

The heat dissipation device 12 is located on the second surface 1122 of the base 112 and thermally connected to the base 112. The heat dissipation device 12 includes a hollow shell 121 and an air pump 124.

The hollow shell 121 is detachably fixed on the second surface 1122 of the base 112. The hollow shell 121 includes a bottom plate 121a, a first sidewall 121b and a second sidewall 121c. The first and second sidewalls 121b, 121c are connected to both the bottom plate 121a and the second surface 1122 of the base 112, and are located at two opposite sides of the bottom plate 121a. The hollow shell 121 has a first opening 122 defined in the first sidewall 121b thereof and a second opening 123 defined in the second sidewall 121c thereof.

The air pump 124 may be detachably fixed on the bottom plate 121a in the hollow shell 121, providing forced convection. The air pump 124 includes a piston 125 and an actuator 126 configured to drive the piston 125.

The piston 125 is configured to oscillate between the first opening 122 and the second opening 123, generating airflow flowing via the first and second openings 122, 123 to evacuate heat from the light source 11.

The piston 125 may be cylindrical with a gap between a top end thereof and the second surface 1122 of the base 112. Further, a bottom end of the piston 125 is applied with lubricant to improve its reciprocating movement on the bottom plate 121 a of the hollow shell 121.

The actuator 126 includes a transmission belt 126a and two rollers 126b, 126c. The transmission belt 126a is mechanically connected to the piston 125 and the rollers 126b, 126c. In this embodiment, both the rollers 126b, 126c drive the transmission belt 126a. In other embodiments, the roller 126b may drive the transmission belt 126a, and the roller 126c is an idle roller driven by the transmission belt 126a.

In operation, heat generated by the LEDs 111 is outwardly transferred to the hollow shell 121, and evacuated by airflow from the air pump 124. The piston 125 is driven by the actuator 126 to oscillate between the first opening 122 and the second opening 123. When the piston 125 is moved from the first opening 122 toward the second opening 123, cold air flows into the hollow shell 121 from the first opening 122, hot air flows out of the hollow shell 121 via the second opening 123 and vice versa. Airflow from hollow shell 121 is rapidly evacuated, with heat generated by the light source 11 efficaciously dissipated correspondingly. Thus, the thermal convection is improved.

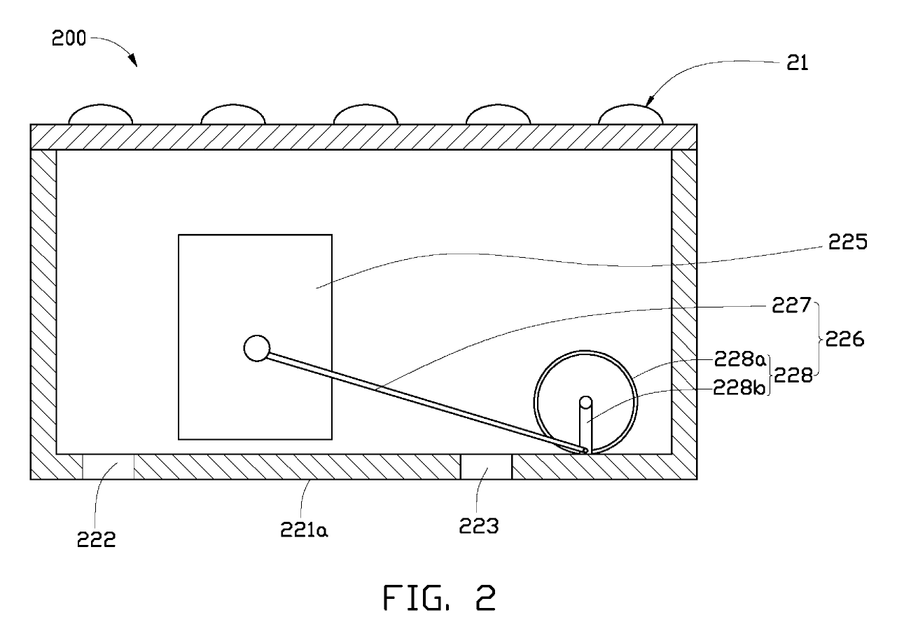

Referring to FIG. 2, an illumination device 200 according to a second embodiment of the present disclosure differs from the first embodiment only in that both the first and second openings 222, 223 are defined in the bottom plate 221a, and the actuator 226 includes a transmission shift 227 and a roller 228. The transmission shift 227 is mechanically connected to both the piston 225 and the roller 228, and the roller 228 is configured to drive the transmission shift 227.

In this embodiment, the roller 228 drives the transmission shift 227, and the transmission shift 227 in turn drives the piston 225 into a reciprocating movement on the bottom plate 221a. The roller 228 may include a roll structure 228a rotatable around its own axis and a driving shift 228b mechanically connected to the transmission shift 227 and the axis of the roll structure 228a.

When the roll structure 228a is rotated, the driving shift 228b drives the transmission shift 227 to move the piston 225, such motion of the piston 225 generating airflow via the first and second openings 222, 223 to evacuate heat from the light source 21.

The arrangements, numbers, positions and structures of the LEDs, base, hollow shell, openings, piston, actuator, transmission belt, rollers and transmission shift can be adjusted as required. For example, the first and second openings 122, 123 (222, 223) may be located in different levels.

It is to be understood, however, that even though numerous characteristics and advantages of various embodiments have been set forth in the foregoing description, together with details of the structures and functions of the embodiments, the disclosure is illustrative only; and that changes may be made in detail, especially in matters of arrangement of parts within the principles of the invention to the full extent indicated by the broad general meaning of the terms in which the appended claims are expressed.

What is claimed is:

1. An illumination device, comprising:
a light source comprising:
a base comprising a first surface and a second surface opposite to the first surface; and
a light emitting diode located on the first surface of the base; and
a heat dissipation device located on the second surface of the base, the heat dissipation device comprising:
a hollow shell detachably fixed on the base, the hollow shell comprising a first opening and a second opening; and
an air pump detachably fixed in the hollow shell, wherein the air pump generates airflow via the first opening and the second opening to evacuate heat from the light source.

2. The illumination device of claim 1, wherein the hollow shell comprises a bottom plate, a first sidewall and a second sidewall, and the first and second sidewalls are connected to both the bottom plate and the second surface of the base.

3. The illumination device of claim 2, wherein the first opening is defined in the first sidewall and the second opening is defined in the second sidewall.

4. The illumination device of claim 2, wherein both the first opening and the second opening are defined in the bottom plate.

5. The illumination device of claim 1, wherein the air pump comprises a piston and an actuator configured to drive the piston.

6. The illumination device of claim 5, wherein the actuator comprises a transmission belt and a first roller, the transmission belt coupled to both the piston and the first roller, and the first roller configured to drive the transmission belt.

7. The illumination device of claim 6, wherein the actuator further comprises a second roller configured to drive the transmission belt.

8. The illumination device of claim 6, wherein the actuator further comprises a second roller driven by the transmission belt.

9. The illumination device of claim 5, wherein the actuator comprises a transmission shift and a roller, the transmission shift coupled to both the piston and the roller, and the roller configured to drive the transmission shift.

10. The illumination device of claim 9, wherein the roller includes a roll structure and a driving shift connected to the transmission shift and an axis of the roll structure.

11. The illumination device of claim 1, wherein the piston oscillates between the first opening and the second opening.
